(19) United States
(12) Patent Application Publication
(10) Pub. No.: US 2025/0306281 A1
(43) Pub. Date: Oct. 2, 2025

(54) ADHESIVE-FREE EXPANDED BEAM FIBER ARRAY UNIT (FAU)

(71) Applicant: Intel Corporation, Santa Clara, CA (US)

(72) Inventors: Kumar Abhishek SINGH, Phoenix, AZ (US); Li YUAN, Fremont, CA (US); Saikumar JAYARAMAN, Chandler, AZ (US); Tim Tri HOANG, San Jose, CA (US); Sergey Yuryevich SHUMARAYEV, Los Altos Hills, CA (US)

(21) Appl. No.: 18/620,737

(22) Filed: Mar. 28, 2024

(51) Int. Cl. G02B 6/26; G02B 6/30

(52) U.S. Cl. CPC G02B 6/262; G02B 6/305

(57) ABSTRACT

Embodiments disclosed herein comprise a substrate with a first surface and a second surface opposite from the first surface. In an embodiment, the substrate comprises a first glass material. In an embodiment, a lens is on the second surface of the substrate, and the lens comprises a second glass material. In an embodiment, a fiber is contacting the first surface of the substrate, and the fiber comprises a third glass material. In an embodiment, fiber is fused to the first surface of the substrate.

### BACKGROUND

Optical data links are potential candidates to address scalability challenges of electrical interconnects over long distances due to their potential for negligible frequency-dependent loss. Optical interconnects based on integrated photonics (e.g., silicon photonics) or discrete photonics (e.g., vertical cavity surface-emitting lasers (VCSELs), micro light emitting diodes (μLEDs), a photodiode (PD), etc.) are used in various applications. The optical signals from these devices are propagated along glass fibers.

Fiber array units (FAUs) are often used to optically couple the glass fibers to the photonic integrated circuit (PIC). The FAU aligns the fibers for efficient optical coupling between the fiber and an input of the PIC. The fibers are placed in V-grooves in the FAU in order to achieve the high degree of alignment necessary for optical coupling. After placing the fiber in the FAU an epoxy is dispensed over the fiber to secure the fiber to the V-groove. In some instances, a lens may be coupled to an end of the fiber with an optical glue. The lens provides improved margin for misalignment.

However, epoxies and glues are not compatible with reflow processes that are often used in the assembly of an optoelectronic package. In the case of a lens attached by glue, the attachment process is often manual and not well controlled. This can lead to unacceptable levels of misalignment. Additionally, in low pressure environments, such as the vacuum of space, the epoxies and glues may outgas. This may lead to degradation of the epoxy or glue.

### BRIEF DESCRIPTION OF THE DRAWINGS

FIG. 1 is a cross-sectional illustration of optically coupled fibers that both include beam expander lenses.

FIG. 2A is a plot of the coupling loss associated with lenses that are off-center from each other.

FIG. 2B is a cross-sectional illustration of lenses that are off-center from each other.

FIG. 2C is a plot of the coupling loss associated with lenses that are angularly misaligned with each other.

FIG. 2D is a cross-sectional illustration of lenses that are angularly misaligned with each other.

FIG. 2E is a plot of the coupling loss associated with lenses that are not spaced properly.

FIG. 2F is a cross-sectional illustration of lenses with a large spacing.

FIG. 3 is an exploded perspective view illustration of a fiber array unit (FAU) with an expanded beam connector (EBC), in accordance with an embodiment.

FIG. 4A is a perspective view illustration of a lens array with a cross-sectional cutaway showing a fiber fused to a lens, in accordance with an embodiment.

FIG. 4B is a cross-sectional illustration of a portion of a lens array with a fiber fused to a lens at an edge of the lens array substrate, in accordance with an embodiment.

FIG. 4C is a cross-sectional illustration of a portion of a lens array with a fiber fused to a lens, and where the lens is also fused to the lens array substrate, in accordance with an embodiment.

FIG. 4D is a perspective view illustration of a lens array with a cross-sectional cutaway showing a fiber fused to a glass substrate with an integrated lens, in accordance with an embodiment.

FIG. 4E is a cross-sectional illustration of a portion of a lens array with a fiber fused to a surface of a glass substrate with an integrated lens, in accordance with an embodiment.

FIG. 5A is a cross-sectional illustration of a portion of an FAU with a fiber fused to surfaces of a V-groove in the FAU substrate, in accordance with an embodiment.

FIG. 5B is a plan view illustration of an FAU with a fiber fused to surfaces of a V-groove in the FAU along substantially an entire length of the V-groove, in accordance with an embodiment.

FIG. 5C is a plan view illustration of an FAU with a fiber fused to surfaces of a V-groove in the FAU at ends of the V-groove, in accordance with an embodiment.

FIG. 5D is a plan view illustration of an FAU with a fiber fused to surfaces of a V-groove in the FAU at a plurality of spots along a length of the V-groove, in accordance with an embodiment.

FIG. 5E is a plan view illustration of an FAU with a fiber fused to surfaces of a V-groove in the FAU at offset locations along a length of the V-groove, in accordance with an embodiment.

FIG. 6A is a cross-sectional illustration of a portion of a lid fused to a fiber, in accordance with an embodiment.

FIG. 6B is a plan view illustration of a lid with a fiber fused to a surface of the lid substrate along substantially an entire length of the lid substrate, in accordance with an embodiment.

FIG. 6C is a plan view illustration of a lid with a fiber fused to a surface of the lid substrate at ends of the lid substrate, in accordance with an embodiment.

FIG. 6D is a plan view illustration of a lid with a fiber fused to a surface of the lid substrate at a plurality of locations along a length of the lid substrate, in accordance with an embodiment.

FIG. 7A is a cross-sectional illustration of a structure with an FAU and a lid that are both fused to a substrate, in accordance with an embodiment.

FIG. 7B is a plan view illustration of a structure with an FAU and a lid where a fiber is fused to both the FAU and the lid along substantially an entire length of a V-groove in the FAU, in accordance with an embodiment.

FIG. 8A is a process flow diagram of a process for fusing a fiber to a V-groove with a laser welding process, in accordance with an embodiment.

FIG. 8B is a process flow diagram of a process for fusing a fiber to a lens in an EBC with a laser welding process, in accordance with an embodiment.

FIG. 9A is a cross-sectional illustration of an optoelectronic system that comprises an FAU with an EBC and a fused glass fiber, in accordance with an embodiment.

FIG. 9B is a cross-sectional illustration of an optoelectronic system that comprises a pair of EBCs with fused glass fibers, in accordance with an embodiment.

FIG. 10 is a schematic of a computing device built in accordance with an embodiment.

### DETAILED DESCRIPTION

Described herein are optoelectronic systems, and more particularly, fiber array units (FAUs) and expanded beam connectors (EBCs) where the fibers are fused to glass substrates and/or glass lenses, in accordance with various embodiments. In the following description, various aspects of the illustrative implementations will be described using terms commonly employed by those skilled in the art to convey the substance of their work to others skilled in the art. However, it will be apparent to those skilled in the art that the present disclosure may be practiced with only some of the described aspects. For purposes of explanation, specific numbers, materials and configurations are set forth in order to provide a thorough understanding of the illustrative implementations. However, it will be apparent to one skilled in the art that the present disclosure may be practiced without the specific details. In other instances, well-known features are omitted or simplified in order not to obscure the illustrative implementations.

Various operations will be described as multiple discrete operations, in turn, in a manner that is most helpful in understanding the present disclosure, however, the order of description should not be construed to imply that these operations are necessarily order dependent. In particular, these operations need not be performed in the order of presentation.

Various embodiments or aspects of the disclosure are described herein. In some implementations, the different embodiments are practiced separately. However, embodiments are not limited to embodiments being practiced in isolation. For example, two or more different embodiments can be combined together in order to be practiced as a single device, process, structure, or the like. The entirety of various embodiments can be combined together in some instances. In other instances, portions of a first embodiment can be combined with portions of one or more different embodiments. For example, a portion of a first embodiment can be combined with a portion of a second embodiment, or a portion of a first embodiment can be combined with a portion of a second embodiment and a portion of a third embodiment.

As noted above, existing fiber coupling options rely on epoxy and glue based adhesives in order to secure the fiber to the glass substrates (e.g., a support block of a fiber array unit (FAU)) and/or to lenses (e.g., in an expanded beam connector (EBC) of an FAU). The use of epoxy and/or glue limits the accuracy of optical alignment. Misalignment (e.g., off-center misalignment, angular misalignment, and/or non-uniform spacing control) can lead to losses in the optical signal as the optical signal passes from a first optical interconnect to a second optical interconnect. Additionally, epoxies and optical glue typically have low melting points. As such, optical alignment and connector systems that use epoxies or glue are not reflow compatible. This is problematic since reflow operations are used in many optoelectronic packaging assembly flows. Furthermore, epoxies and glues may outgas in vacuum environments (such as space). The outgassing may degrade the epoxies and glues, which limits their effectiveness and/or lifespans in such environments.

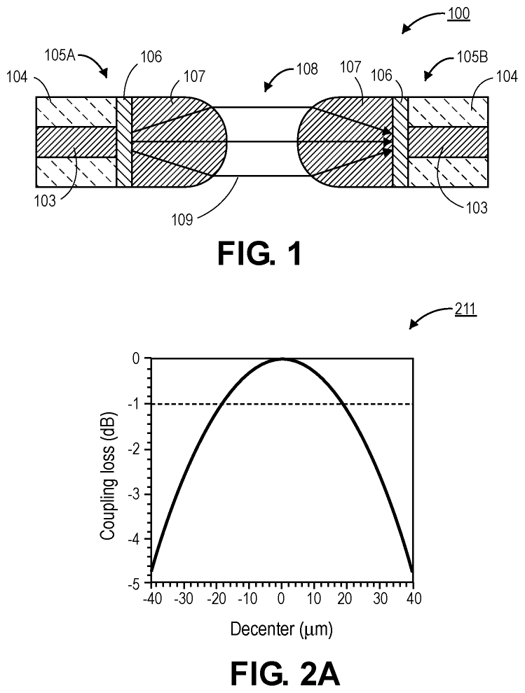

Referring now to FIG. 1, a cross-sectional illustration of an optical coupling 100 is shown. The optical coupling 100 may comprise a first interconnect 105A that faces a second interconnect 105B. Each of the interconnects 105 may comprise a fiber 103 that is provided within a block 104, such as a glass block 104. The fiber 103 may pass through a hole in the block 104. Though, other architectures may include a fiber 103 that is attached to a surface of a glass block 104. A lens 107 may be attached to an end of the fiber 103 by an optical glue 106. The optical glue 106 may be optically transparent in order to allow optical signals 109 to pass from the fiber 103 to the lens 107.

The lenses 107 may be beam expander lenses 107. As such, a beam may be expanded as shown by the plurality of optical signals 109 in FIG. 1. The expanded beam allows for more alignment tolerance between the interconnects 105A and 105B. Ends of the lenses 107 may be spaced apart by a gap 108.

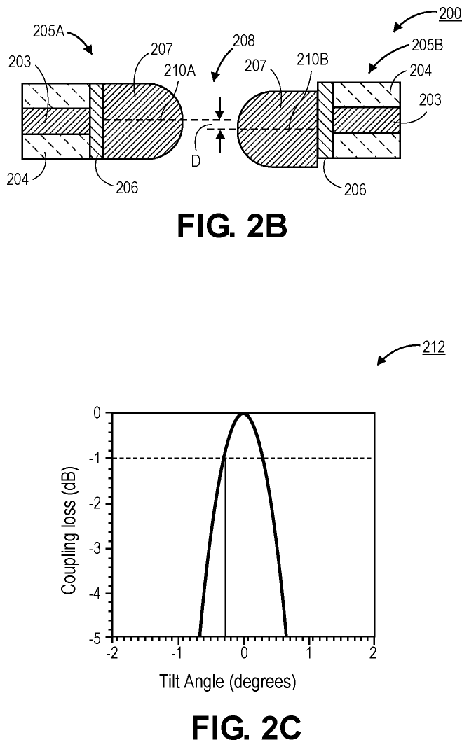

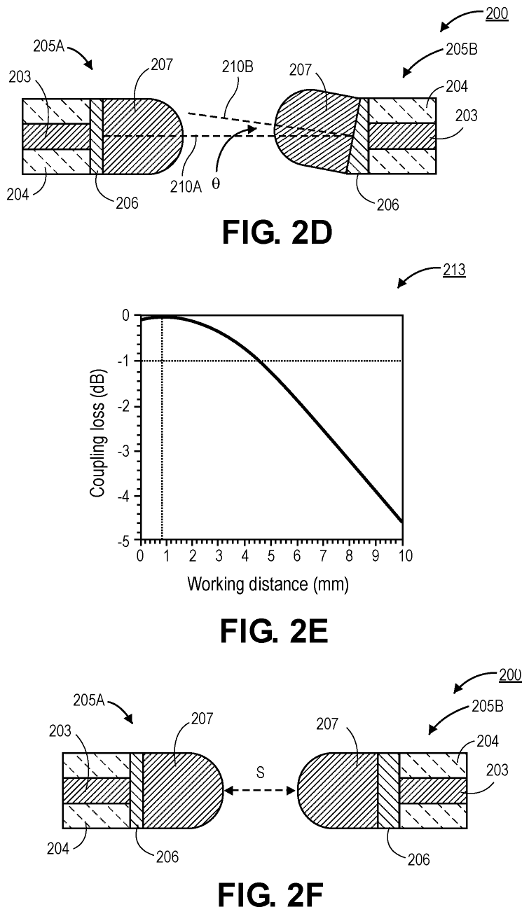

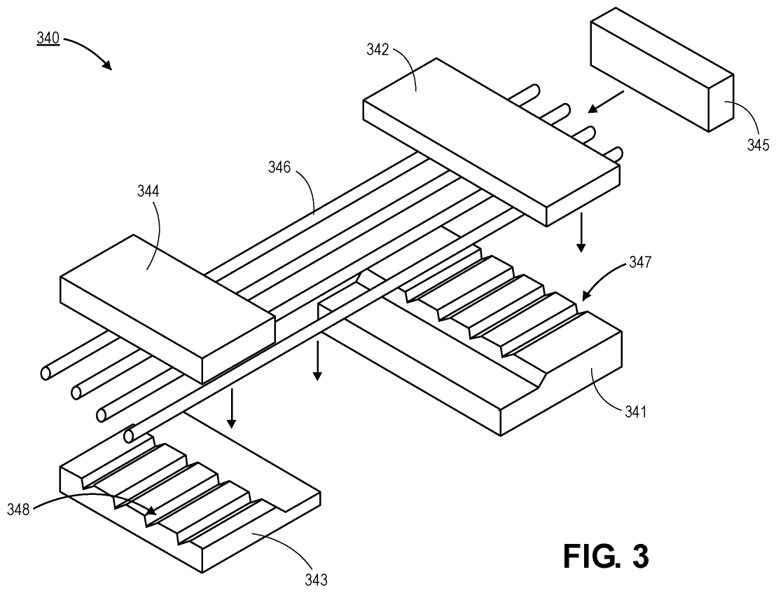

Despite the use of beam expander lenses 107, the optical coupling is still limited by the accuracy of the alignment. Particularly, misalignment, such as off-center misalignment, angular misalignment, or sub-optimal distance between the lenses, can result in significant coupling losses. Examples of such misalignment and the corresponding coupling losses are shown in FIGS. 2A-2F.

Referring now to FIGS. 2A and 2B, a plot 211 of off-center misalignment and coupling loss (FIG. 2A) and a cross-sectional illustration of an off-center optical coupling 200 (FIG. 2B) are shown. As shown, each interconnect 205A and 205B comprises a fiber 203 within a block 204, and the fiber is attached to a lens 207 by a glue 206. The interconnects 205A and 205B may be spaced apart by a gap 208. The lens 207 of interconnect 205A has a first centerline 210A, and the lens 207 of interconnect 205B has a second centerline 210B. As shown, the centerlines are offset from each other by a distance D.

It is to be appreciated that the lenses 207 may be offset from each other as a result of the attachment to the glue 206. For example, the lens 207 of the interconnect 205B is shifted down relative to the fiber 203 of the interconnect 205B. This can be the result of a manual attachment process, or through the shifting of the glue 206 or lens 207 during the attachment process. That is, the use of glue 206 as an attachment mechanism may not maintain the proper alignment of the fibers 203. As shown in FIG. 2A, even small offset distances D can result in significant coupling losses, which may significantly degrade signal quality. For example, at even a 20 μm offset distance D, an approximately −1 dB loss can occur.

Referring now to FIGS. 2C and 2D, a plot 212 of angular misalignment (i.e., tilt angle) and coupling loss (FIG. 2C) and a cross-sectional illustration of an angularly misaligned optical coupling 200 (FIG. 2D) are shown. As shown in FIG. 2D, the centerline 210A of the lens 207 of the interconnect 205A is oriented at an angle θ relative to the centerline 210B of the lens 207 of the interconnect 205B. It is to be appreciated that such an angular orientation offsets can be generated through attachment of the lens 207 to the glue 206. For example, if the force applied to the lens 207 is not uniformly perpendicular to the surface of the glue 206, then one end (e.g., the top end of the lens 207 of interconnect 205B) can be pressed further into the glue 206. Alternatively, if the glue 206 does not have a uniform thickness when applied, the lens 207 may also be attached at an angle. As shown in FIG. 2C, small misalignments in the angle θ can result in significant coupling losses. For example, an offset angle θ of even 0.3° can result in a decrease in optical coupling of approximately −1 dB, and the optical coupling decreases rapidly to −5 dB at an offset angle θ of approximately 0.7°.

Referring now to FIGS. 2E and 2F, a plot 213 of working distance misalignment and coupling loss (FIG. 2E) and a cross-sectional illustration of an optical coupling 200 illustrating the working distance S (FIG. 2F) are shown. As can be appreciated, the distance S between the lenses 207 of the interconnects 205A and 205B may be difficult to control when the lenses 207 need to be pushed against a deformable glue 206. Pressing with a non-uniform force between interconnects 205A and 205B can result in the glue 206 being compressed in different amounts. For example, the compressed thickness of the glue 206 in the interconnect 205A is different than the compressed thickness of the glue 206 in the interconnect 205B. While control of working distance S may be less sensitive than other forms of misalignment, FIG. 2E still shows a significant increase in coupling loss after the working distance exceeds 1 mm. For example, coupling losses in excess of −1 dB may occur at working distances S that are greater than approximately 4.5 mm.

Each form of misalignment along can be enough to significantly degrade the optical coupling efficiency of the optical coupling between interconnects 205A and 205B. However, in many instances multiple different misalignments are compounded with each other in order to provide significant losses in optical coupling efficiency. The use of glue 206 as the coupling mechanism between the lens 207 and the fiber 203 leaves open many degrees of freedom that are susceptible to generating one or more of forms of misalignment.

Accordingly, embodiments disclosed herein may include an improved coupling mechanism that omits the use of a glue or other adhesive material. Instead, the glass material of the lens is fused to the glass material of the fiber. Alternatively, a glass substrate with an integrated lens is fused to the fiber. In some embodiments, the fusing process may be implemented through the use of a laser welding process. Removing the presence of glue has several benefits. For example, variability in alignment due to attachment process is reduced. Instead of pressing the lens against a deformable layer, the lens is pressed against a precisely manufactured and substantially non-deformable glass surface. Accordingly, angular misalignment and working distance variability is substantially omitted. The off-center misalignment is also reduced through the use of automated attachment processes that hold the fiber and lens in position during the fusion process. Additionally, the elimination of glue increases the reflow compatibility of the structure since low melting point materials are eliminated. This reduces complexity of optoelectronic package assembly. Furthermore, the removal of glue allows for applications in low pressure or vacuum environments (e.g., space) since there is no longer risk of degradation through outgassing.

Embodiments disclosed herein include optical structures that include fused glass surfaces between components within an optical interconnect transmission line (e.g., fibers and lenses in an EBC). Though, embodiments may also use similar fusion processes for other components within an optical coupling system. For example, glass fibers may also be fused to V-groove surfaces of glass alignment blocks and/or glass lids (e.g., in an FAU). The use of fusion processes for the alignment blocks and/or lids of an FAU may be beneficial for similar reasons to those when fusion is used in an EBC. For example, fibers are typically retained in the V-grooves by an epoxy that can be damaged during reflow and/or outgas in low pressure environments. As such, the fusion processes allow FAU structures to also be used in the presence of reflow processes and/or in vacuum environments. Epoxy is also difficult to dispense in a controlled manner. This may result in epoxy flowing into designated epoxy keep out zones (KOZs). Accordingly, the complete elimination of epoxy allows for greater protection to KOZs of the system.

As noted above the fusion process may include a laser welding process. In a laser welding process, a laser (e.g., a pulsed laser) is focused on the interface between glass surfaces. The laser locally heats up the glass so that a localized region of the glass on each surface melts. The melted regions on each surface coalesce and form a single volume. Upon solidification, a monolithic structure is provided. It is to be appreciated that such laser welding processes can result in an interface that comprises a material composition that is substantially the same as the remainder of the glass that was not melted. Though, in some instances, a visible seam may be present. When a visible seam is present, the seam may not significantly impact performance of the optical transmission across the seam since the materials are substantially the same composition. The materials may also include substantially the same refractive index to provide transmission without any significant amount of reflection. Accordingly, the term “seamless” as used herein may refer to an interface that has negligible effect on the transmission of optical signals across the interface. In some embodiments, a “seamless” interface may have a visual indication of a fusion process when investigated with certain visual inspection tools. Though, a “seamless” interface may not have any visual indication of a fusion process in other embodiments.

Referring now to FIG. 3, an exploded perspective view of an FAU 340 is shown, in accordance with an embodiment. In an embodiment, the FAU 340 may be used to couple optical fibers 346 (e.g. glass fibers 346) to a photonics integrated circuit (PIC) (not shown) or any other optical component or system. For example, a first FAU 340 may be optically coupled to a second FAU (not shown). In an embodiment, the ends of the fibers 346 are coupled to an EBC 345. The EBC 345 may comprise a glass substrate with holes (not shown) for receiving the fibers 346. The opposite face of the EBC 345 may comprise lenses (not shown) that are fused to ends of the fibers 346 (as will be described in greater detail below).

In an embodiment, the fibers 346 may be set into V-grooves 347 on a surface of a first support block 341. The fibers 346 may be fused to surfaces of the V-grooves 347 in some embodiments. A first lid 342 may be placed over the top of the fibers 346 within the V-grooves 347. In some instances, the first lid 342 may also be fused to the fibers 346. In an embodiment, a second support block 343 with V-grooves 348 may also be provided for supporting the fibers 346. A second lid 344 may be placed over the fibers 346 in the V-grooves 348 of the second support block 343. In an embodiment, the fibers 346 may be fused to one or both of the second support block 343 or the second lid 344. While a first support block 341 and a second support block 343 are described in FIG. 3, it is to be appreciated that the FAU 340 may comprise one or more support blocks.

As used herein, a “V-groove” may generally refer to a recess into a substrate that is used to align and/or retain a fiber. For example, a V-groove may have a pair of sloping sidewalls that come to a point at a bottom of the V-groove. In other instances, a V-groove may have sloped sidewalls with bottoms that are connected together by a bottom surface (e.g., a horizontal surface or a curved surface). In such an embodiment, the bottom surface may be below a bottom surface of the fiber so that only the sloping sidewall surfaces contact the fiber. A V-groove may also refer to a groove with vertical sidewalls with a flat bottom surface, a curved bottom surface, or the like. In some instances a V-groove may include a U-shaped groove. More generally, a “groove” may refer to a V-groove or any other type of structure into a surface of a substrate for aligning a fiber. A groove may have a V-shape, a U-shape, or any other suitable shape.

In the illustrated embodiment, the FAU 340 comprises four fibers 346. However, it is to be appreciated that FAUs 340 may comprise one or more fibers 346. For example, the FAU 340 may comprise 12 or more fibers 346, or 24 or more fibers 346. In some instances, the ability to provide high precision alignment with rapid fusing through laser welding may enable FAUs 340 that are capable of extreme scaling to provide up to a thousand or more fibers 346.

In an embodiment, the glass structures and/or components described herein (e.g., glass fibers 346, EBCs 345, glass blocks 341 or 343, lids 342 or 344, etc.) may include any suitable glass formulation that has the necessary mechanical robustness and compatibility with optics manufacturing and assembly processes. For example, the glass components may comprise aluminosilicate glass, borosilicate glass, alumino-borosilicate glass, silica, fused silica, or the like. In some embodiments, the glass components may include one or more additives, such as, but not limited to, Al₂O₃, B₂O₃, MgO, CaO, SrO, BaO, SnO₂, Na₂O, K₂O, SrO, P₂O₃, ZrO₂, Li₂O, Ti, or Zn. More generally, the glass components may comprise silicon and oxygen, as well as any one or more of aluminum, boron, magnesium, calcium, barium, tin, sodium, potassium, strontium, phosphorus, zirconium, lithium, titanium, or zinc. In an embodiment, the glass components may comprise at least 23 percent silicon (by weight) and at least 26 percent oxygen (by weight). In some embodiments, the glass components may further comprise at least 5 percent aluminum (by weight).

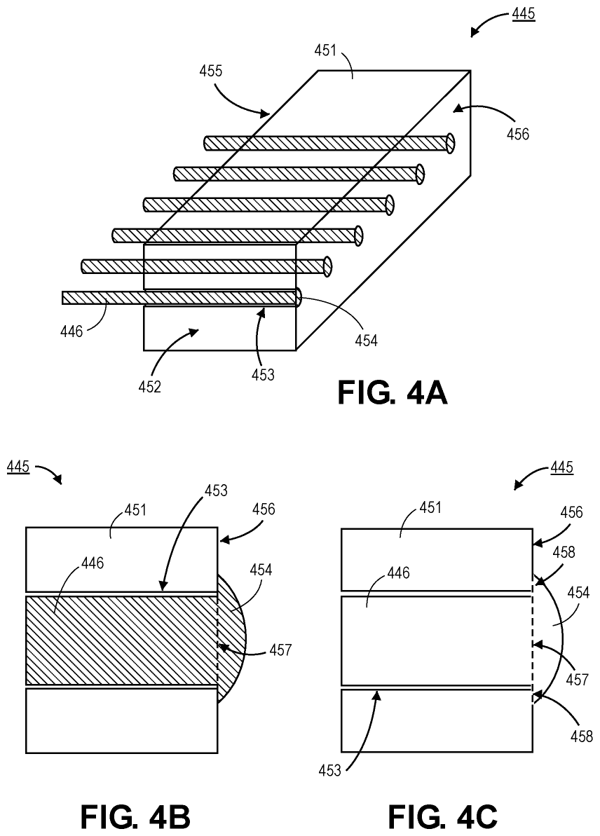

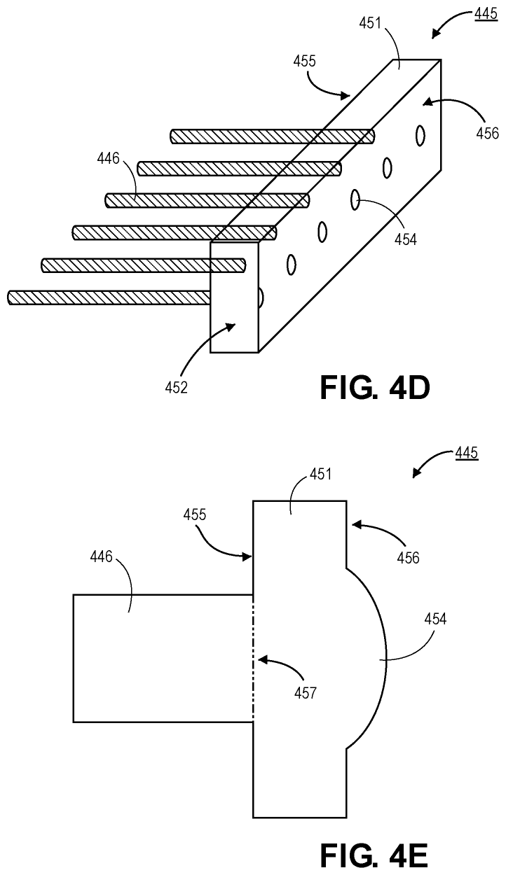

Referring now to FIG. 4A, a perspective view illustration of an EBC 445 with a sectional view along the front surface 452 is shown, in accordance with an embodiment. The EBC 445 may comprise a glass substrate 451. Holes 453 may be provided through a thickness of the glass substrate 451 from a first surface 455 to a second surface 456. In the illustrated embodiment, the holes 453 are shown as having a diameter that is slightly larger than a diameter of the fibers 446 for illustrative purposes. In other embodiments, the holes 453 may have a diameter that is larger enough to insert the fibers 446 with minimal room for fiber 446 movement within the holes 453.

In an embodiment, the fibers 446 pass through the holes 453 and contact a surface of lenses 454 that are on the second surface 456. The ends of the fibers 446 may be fused to the lenses 454 (e.g., with a laser welding process). The lenses 454 may have diameters that are larger than diameters of the fibers 446 and diameters of the holes 453. This allows for each lens 454 to contact a fiber 446 and the second surface 456 of the glass substrate 451. In an embodiment, the lenses 454 may be beam expander lenses or any other suitable type of lens for optical coupling.

Referring now to FIG. 4B, a zoomed in cross-sectional illustration of the interface 457 between a fiber 446 and a lens 454 in an EBC 445 is shown, in accordance with an embodiment. In an embodiment, the fiber 446 is fused to the lens 454 at the interface 457, which is indicated with a dashed line. The interface 457 may not be visually discernable in some embodiments. In other embodiments a visual difference at the interface may be present. However, in some embodiments, the interface 457 may be considered as being seamless as a result of a substantially uniform material composition and/or substantially uniform refractive index. Further, the fiber 446 and the lens 454 may be considered as being a monolithic glass structure since there is no physical break between the two components. Stated differently, the fiber 446 and the lens 454 may share a continuous microstructure (e.g., a continuous amorphous microstructure).

In the illustrated embodiment, the fused interface 457 is across an entire end surface of the fiber 446. In other embodiments, only portions of the end surface of the fiber 446 may be fused to the lens 454. For example, a fused interface may be provided around an outer perimeter of the fiber 446, at a center of the lens 454, or at any one or more other locations at the end of the fiber 446.

Referring now to FIG. 4C, a cross-sectional illustration of a portion of an EBC 445 is shown, in accordance with an additional embodiment. In an embodiment, the EBC 445 may be similar to the EBC 445 in FIG. 4B, with the exception of the lens 454 also being fused to the glass substrate 451. For example, fused interfaces 458 may be provided proximate to an outer perimeter of the lens 454. In such an embodiment, the entire EBC 445 may be considered as being a monolithic glass structure (i.e., the fibers 446, the lenses 454, and the glass substrate 451 may all be part of a continuous glass structure).

Referring now to FIG. 4D, a perspective view illustration of an EBC 445 with a sectional view along the front surface 452 is shown, in accordance with an alternative embodiment. The EBC 445 may comprise a glass substrate 451. In an embodiment, the lenses 454 may be integrated with the glass substrate 451 as a single monolithic structure. Though, in some embodiments, the lenses 454 may be fused to the second surface 456 of the glass substrate 451. In an embodiment, the fibers 446 contact the first surface 455 of the glass substrate 451. That is, the ends of the fibers 446 may be fused to the first surface 455 of the glass substrate 451 (e.g., with a laser welding process). In an embodiment, the lenses 454 may be a beam expander lenses or any other suitable type of lens for optical coupling.

Referring now to FIG. 4E, a zoomed in cross-sectional illustration of the interface 457 between a fiber 446 and the first surface 455 of the glass substrate 451 in an EBC 445 is shown, in accordance with an embodiment. In an embodiment, the fiber 446 is fused to the first surface 455 of the glass substrate 451 at the interface 457, which is indicated with a dashed line. The interface 457 may not be visually discernable in some embodiments. In other embodiments a visual difference at the interface may be present. However, in some embodiments, the interface 457 may be considered as being seamless as a result of a substantially uniform material composition and/or substantially uniform refractive index. Further, the fiber 446 and the glass substrate 451 may be considered as being a monolithic glass structure since there is no physical break between the two components. Stated differently, the fiber 446 and the glass substrate 451 may share a continuous microstructure (e.g., a continuous amorphous microstructure).

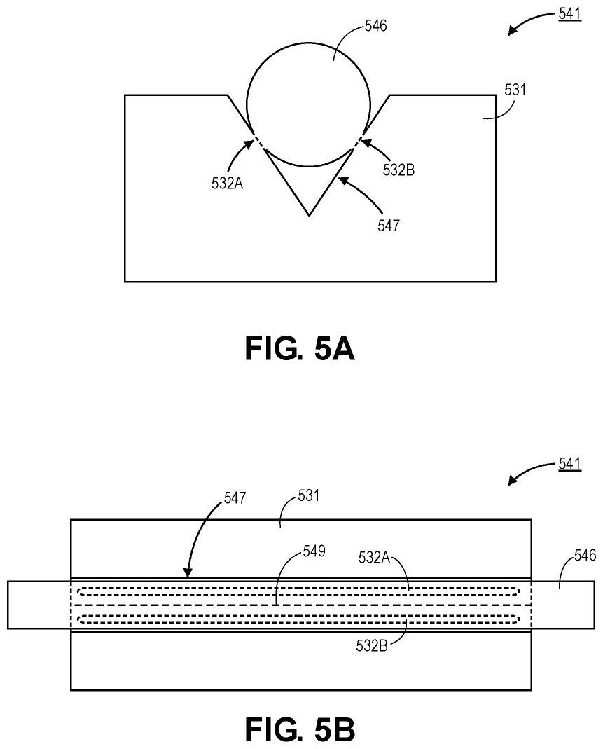

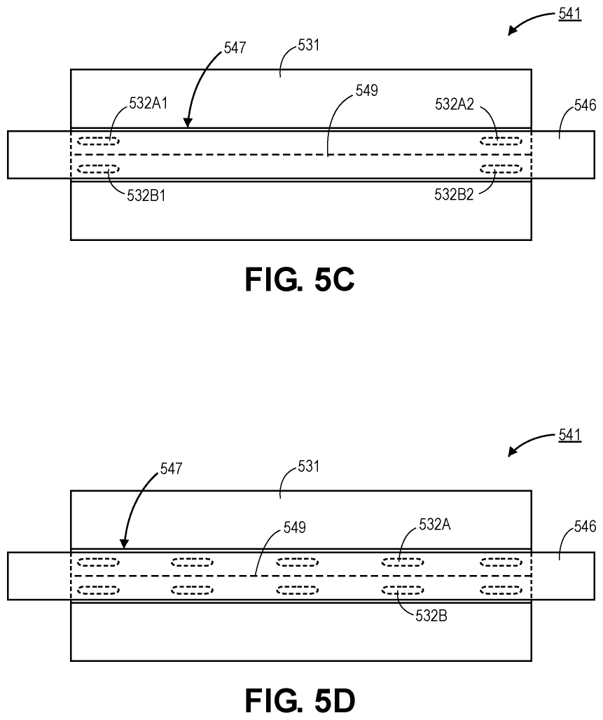

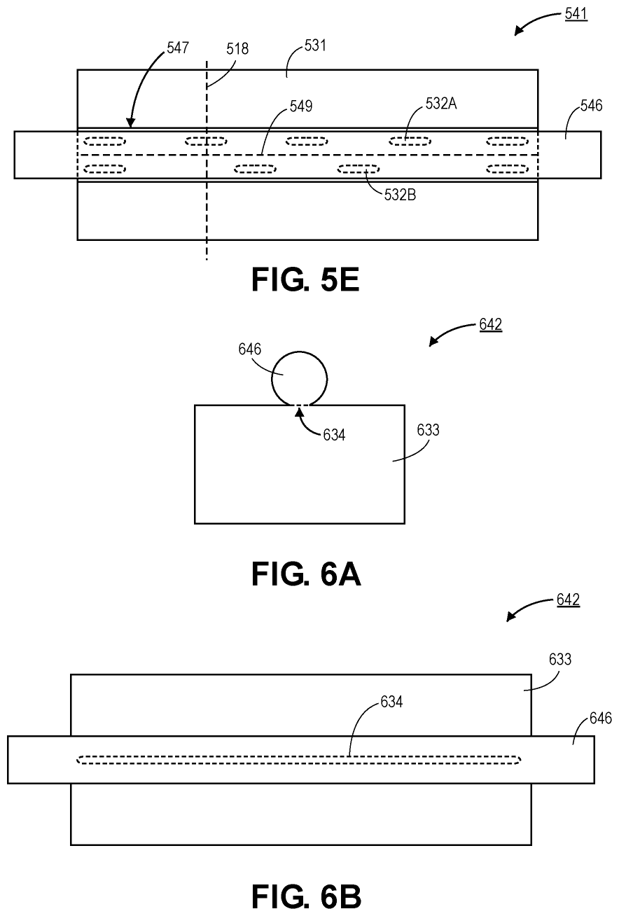

Referring now to FIG. 5A, a cross-sectional illustration of a portion of a support block 541 is shown, in accordance with an embodiment. The support block 541 may be similar to any of the support blocks that form a part of an FAU in the embodiments described above. In an embodiment, the support block 541 may comprise a glass substrate 531. A V-groove 547 may be provided into a surface of the glass substrate 531. As shown, a fiber 546 may be inserted into the V-groove 547. Due to the sloping sidewalls of the V-groove 547, the fiber 546 may contact the substrate 531 at two points (when viewed in a cross-sectional plane). A fusion process (e.g., laser welding) may be used in order to secure the fiber 546 to the glass substrate 531.

As shown, interfaces 532A and 532B are provided between the fiber 546 and the V-groove 547 of the glass substrate 531. The fused interfaces 532A and 532B are indicated with dashed lines in FIG. 5A. In an embodiment, the fused interfaces 532A and 532B may be similar to the fused interface 457 described in greater detail above. For example, the interfaces 532A and 532B may not be visually discernable in some embodiments. In other embodiments a visual difference at the interfaces 532A and 532B may be present. However, in some embodiments, the interfaces 532A and 532B may be considered as being seamless as a result of a substantially uniform material composition and/or substantially uniform refractive index. Further, the fiber 546 and the glass substrate 531 may be considered as being a monolithic glass structure since there is no physical break between the two components. Stated differently, the fiber 546 and the glass substrate 531 may share a continuous microstructure (e.g., a continuous amorphous microstructure).

In an embodiment, the fused interfaces 532A and 532B may have any suitable length along a length of the V-groove (e.g., into and out of plane of FIG. 5A). Examples of different fusing options are shown in the plan view illustrations of FIGS. 5B-5E.

Referring now to FIG. 5B, a plan view illustration of a portion of a support block 541 is shown, in accordance with an embodiment. As shown, a first fused interface 532A is on one side of the bottom point 549 of the V-groove 547, and a second fused interface 532B is on an opposite side of the bottom point 549 of the V-groove 547. As shown, the first and second fused interfaces 532A and 532B extend along substantially an entire length of the V-groove 547. For example, the fused interfaces 532A and 532B may extend 75% or more of a length of the V-groove 547, 90% or more of a length of the V-groove 547, 99% or more of a length of the V-groove 547, or the entire length of the V-groove 547.

Referring now to FIG. 5C, a plan view illustration of a portion of a support block 541 is shown, in accordance with an embodiment. As shown, a first fused interface 532A1 and a second fused interface 532A2 are on one side of the bottom point 549 of the V-groove 547 and a third fused interface 532B1 and a fourth fused interface 532B2 are on an opposite side of the bottom point 549 of the V-groove 547. The first fused interface 532A1 and the third fused interface 532B1 may be at a first end of the V-groove 547, and the second fused interface 532A2 and the fourth fused interface 532B2 may be at a second end of the V-groove 547. That is, discrete fusion points may be provided along a length of the V-groove 547 in some embodiments. Providing discrete fusion points may sufficiently secure the fiber 546 with a shorter process than fusing the entire length of the fiber 546.

Referring now to FIG. 5D, a plan view illustration of a portion of a support block 541 is shown, in accordance with an embodiment. As shown, first fused interfaces 532A are on one side of the bottom point 549 of the V-groove 547, and second fused interfaces 532B are on an opposite side of the bottom point 549 of the V-groove 547. Adding more fusion points may improve the mechanical attachment between the fiber 546 and the glass substrate 531 compared to fusing just the ends of the fiber 546.

Referring now to FIG. 5E, a plan view illustration of a portion of a support block 541 is shown, in accordance with an embodiment. As shown, first fused interfaces 532A are on one side of the bottom point 549 of the V-groove 547, and second fused interfaces 532B are on an opposite side of the bottom point 549 of the V-groove 547. In FIG. 5E, one or more of the first fused interfaces 532A are offset from nearest second fused interfaces 532B. That is, within a single cross-section (e.g., a cross-section along line 518), a single fusion point between the fiber 546 and the glass substrate 531 may be present.

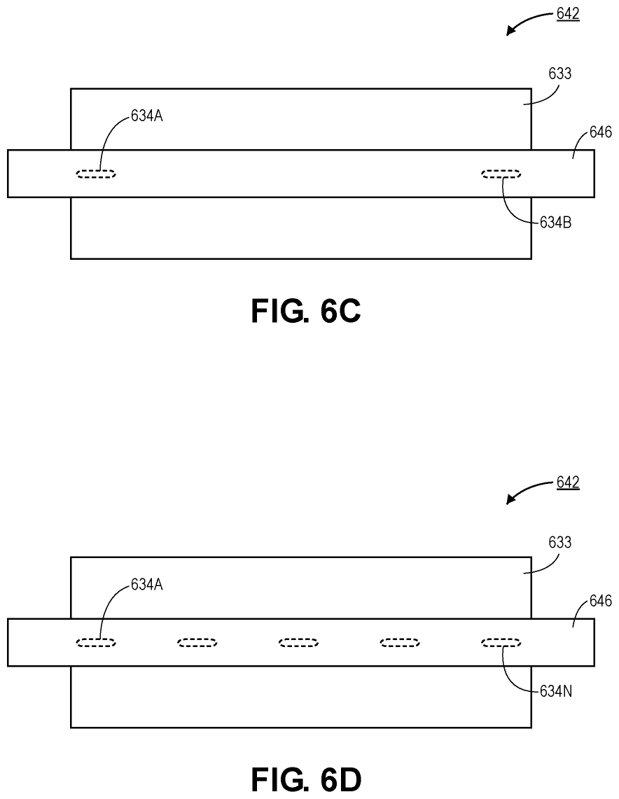

Referring now to FIG. 6A, a cross-sectional illustration of a portion of a lid 642 is shown, in accordance with an embodiment. The lid 642 may be similar to any of the lids that form a part of an FAU in the embodiments described above. In an embodiment, the lid 642 may comprise a glass substrate 633. The substrate 633 may have a flat surface that contacts the fiber 646. A fusion process (e.g., laser welding) may be used in order to secure the fiber 646 to the glass substrate 633.

As shown, an interface 634 is provided between the fiber 646 and the surface of the glass substrate 633. The fused interface 634 is indicated with dashed lines in FIG. 6A. In an embodiment, the fused interface 634 may be similar to any of the fused interfaces described in greater detail above. For example, the interface 634 may not be visually discernable in some embodiments. In other embodiments a visual difference at the interface 634 may be present. However, in some embodiments, the interface 634 may be considered as being seamless as a result of a substantially uniform material composition and/or substantially uniform refractive index. Further, the fiber 646 and the glass substrate 633 may be considered as being a monolithic glass structure since there is no physical break between the two components. Stated differently, the fiber 646 and the glass substrate 633 may share a continuous microstructure (e.g., a continuous amorphous microstructure).

In an embodiment, the fused interface 634 may have any suitable length along a length of the glass substrate 633 (e.g., into and out of plane of FIG. 6A). Examples of different fusing options are shown in the plan view illustrations of FIGS. 6B-6D.

Referring now to FIG. 6B, a plan view illustration of a portion of a lid 642 is shown, in accordance with an embodiment. As shown, a fused interface 634 extends along substantially an entire length of the glass substrate 633. For example, the fused interface 634 may extend 75% or more of a length of the glass substrate 633, 90% or more of a length of the glass substrate 633, 99% or more of a length of the glass substrate 633, or the entire length of the glass substrate 633.

Referring now to FIG. 6C, a plan view illustration of a portion of a lid 642 is shown, in accordance with an embodiment. As shown, a first fused interface 634A and a second fused interface 634B are at opposite ends of the glass substrate 633. That is, discrete fusion points may be provided along a length of the glass substrate 633 in some embodiments. Providing discrete fusion points may sufficiently secure the fiber 646 with a shorter process than fusing the entire length of the fiber 646.

Referring now to FIG. 6D, a plan view illustration of a portion of a lid 642 is shown, in accordance with an embodiment. As shown, fused interfaces 634A-634N are provided in a line along a length of the glass substrate 633. Adding more fusion points may improve the mechanical attachment between the fiber 646 and the glass substrate 633 compared to fusing just the ends of the fiber 646.

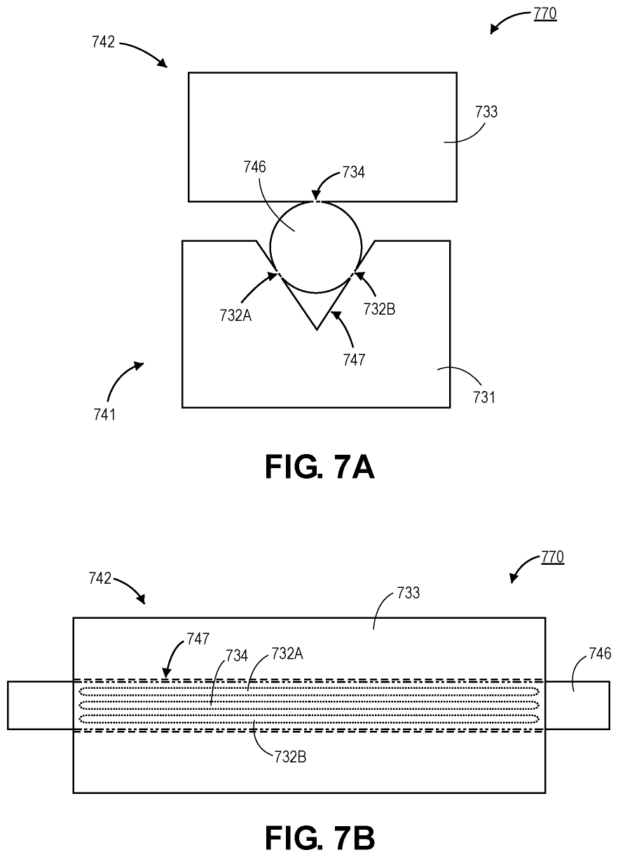

Referring now to FIG. 7A, a cross-sectional illustration of an assembly 770 comprising a support block 741 and a lid 742 for securing a fiber 746 is shown, in accordance with an embodiment. The support block 741 and the lid 742 may be similar to any of the support blocks or lids that form a part of an FAU in the embodiments described above. In an embodiment, the support block 741 may comprise a glass substrate 731 with a V-groove 747 formed into a surface of the glass substrate 731. As shown, the fiber 746 may be inserted into the V-groove 747, and the fiber 746 may contact the substrate 731 at two points (when viewed in a cross-sectional plane). A fusion process (e.g., laser welding) may be used in order to secure the fiber 746 to the glass substrate 731. In an embodiment, the lid 742 may comprise a glass substrate 733. The glass substrate 733 may have a flat surface that contacts the fiber 746. A fusion process (e.g., laser welding) may be used in order to secure the fiber 746 to the glass substrate 733.

Accordingly, the fiber 746 in assembly 770 may be fused at three points when viewed in a cross-sectional plane. As shown, interfaces 732A and 732B are provided between the fiber 746 and the V-groove 747 of the glass substrate 731, and interface 734 is provided between the fiber 746 and the glass substrate 733. The fused interfaces 732A, 732B, and 734 are indicated with dashed lines in FIG. 7A. In an embodiment, the fused interfaces 732A, 732B, and 734 may be similar to the fused interfaces described in greater detail above. For example, the interfaces may not be visually discernable in some embodiments. In other embodiments a visual difference at the interfaces may be present. However, in some embodiments, the interfaces may be considered as being seamless as a result of a substantially uniform material composition and/or substantially uniform refractive index. Further, the fiber 746, the glass substrate 731, and the glass substrate 733 may be considered as being a monolithic glass structure since there is no physical break between the three components. Stated differently, the fiber 746, the glass substrate 731, and the glass substrate 733 may share a continuous microstructure (e.g., a continuous amorphous microstructure).

In an embodiment, the fused interfaces 732A, 732B, and 734 may have any suitable length along a length of the assembly 770 (e.g., into and out of plane of FIG. 7A). FIG. 7B provides one example, where all three interfaces 732A, 732B, and 734 extend along a substantially entire length of the assembly 770. Though, any fusion pattern (or combination of fusion patterns) similar to those described in greater detail herein may be used. For example, discrete fusion points between the fiber 746 and one or both of the glass substrates 731 or 733 may be used in some embodiments.

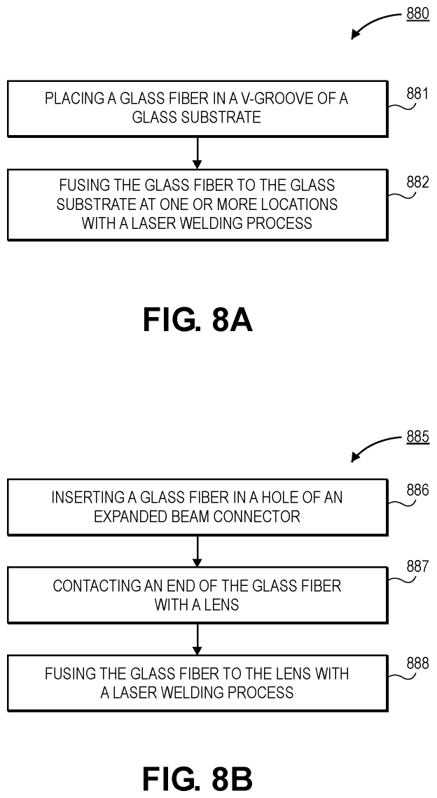

Referring now to FIG. 8A, a process flow diagram of a process 880 for fusing a glass fiber to a V-groove in a glass substrate is shown, in accordance with an embodiment. In an embodiment, the process may begin with operation 881, which comprises placing a glass fiber in a V-groove of a glass substrate. In an embodiment, the glass substrate may be part of an FAU, such as any of the FAUs described in greater detail herein. The process 880 may continue with operation 882, which comprises fusing the glass fiber to the glass substrate at one or more locations with a laser welding process. In an embodiment, the laser welding process includes a laser that can be focused at the interface between the glass fiber and the glass substrate. The laser may be a pulsed laser. Application of laser energy may be used to locally melt portions of the glass substrate and the glass fiber, and the solidification of the melted portions results in the formation of a fused interface between the glass fiber and the V-groove.

Referring now to FIG. 8B, a process flow diagram of a process 885 for fusing a glass fiber to a lens is shown, in accordance with an embodiment. In an embodiment, the process 885 may begin with operation 886, which comprises inserting a glass fiber into a hole of an expanded beam connector. In an embodiment, the expanded beam connector may comprise a glass substrate with the hole through an entire thickness of the glass substrate. In an embodiment, the process 885 may continue with operation 887, which comprises contacting an end of the glass fiber with a lens. In an embodiment, the process 885 may continue with operation 888, which comprises fusing the glass fiber to the lens with a laser welding process. In an embodiment, the laser welding process includes a laser that can be focused at the interface between the glass fiber and the lens. The laser may be a pulsed laser. Application of laser energy may be used to locally melt portions of the lens and the glass fiber, and the solidification of the melted portions results in the formation of a fused interface between the glass fiber and the lens.

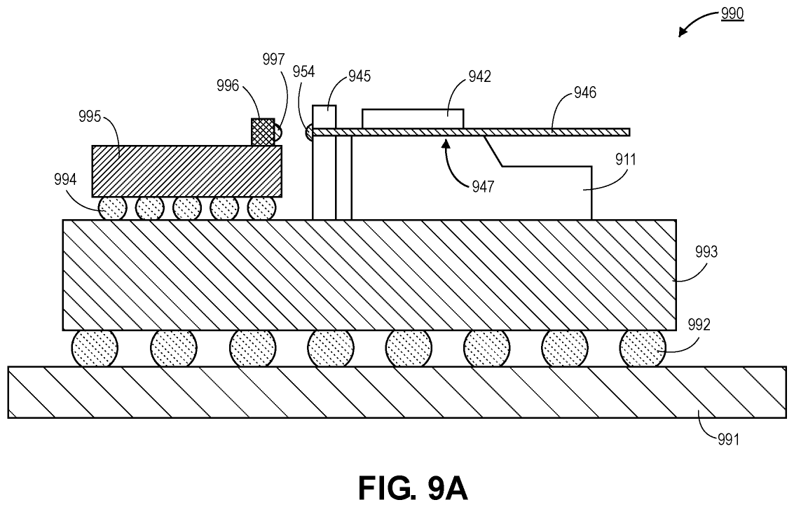

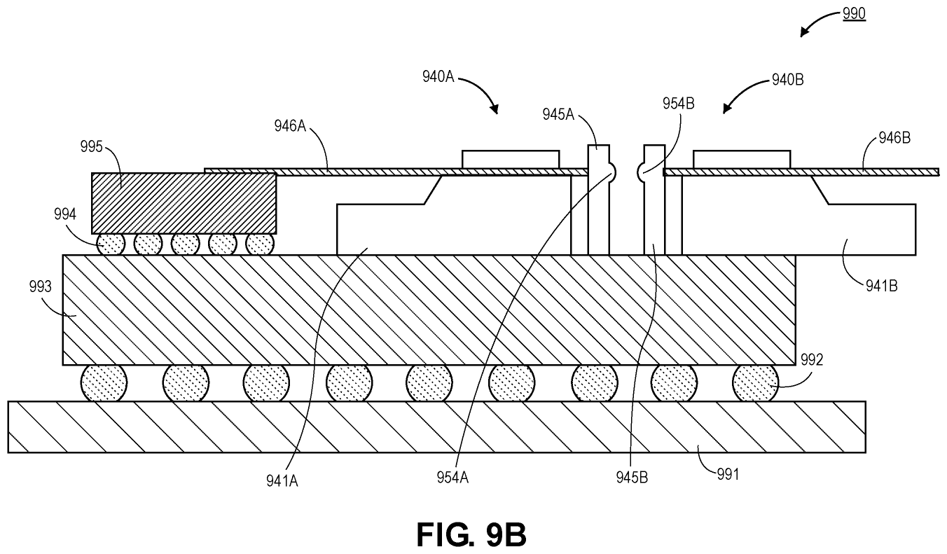

Referring now to FIG. 9A, a cross-sectional illustration of an optoelectronic system 990 is shown, in accordance with an embodiment. The electronic system 990 may comprise a board 991, such as a printed circuit board (PCB), a motherboard, or the like. The board 991 may be coupled to a package substrate 993 through second level interconnects (SLIs) 992. The SLIs 992 may comprise solder joints, pins, sockets, or the like.

In an embodiment, the optoelectronic system 990 may comprise an FAU for coupling with a PIC 995 by an optical coupler 996 with a lens 997. In an embodiment, the FAU may comprise an EBC 945. In an embodiment, the EBC 945 comprises a lens 954 (e.g., a beam expander lens) that is fused to an end of a fiber 946. In an embodiment, the FAU may further comprise a support block 941 with a lid 942 over the fiber 946. In an embodiment, the support block 941 may comprise a V-groove 947 to help improve alignment of the fiber 946. The fiber 946 may be fused to one or both of the lid 942 or the support block 941. Accordingly, embodiments may include an optical coupling structure that is free from epoxies and/or glues. This improves alignment, improves reflow compatibility, and allows for operation in vacuum environments.

In an embodiment, the PIC 995 may be coupled to the package substrate 993 by any suitable first level interconnect (FLI) 994 architecture. For example, FLIs 994 may comprise solder bumps, copper bumps, hybrid bonding, and/or the like. In an embodiment, the PIC 995 may convert optical signals to electrical signals and vice-versa. The PIC 995 may be communicatively coupled to a die (not shown) that is configured to process data delivered along the optical fiber 946. The die may be any type of die, such as a central processing unit (CPU), a graphics processing unit (GPU), an XPU, a communications die, a memory die, or the like.

Referring now to FIG. 9B, a cross-sectional illustration of an optoelectronic system 990 is shown, in accordance with an additional embodiment. The optoelectronic system 990 in FIG. 9B may be similar to the optoelectronic system 990 in FIG. 9A, except for the optical coupling to the PIC 995. For example, a first fiber 946A from a first FAU 940A sits into a V-groove in the PIC 995. The opposite end of the first FAU 940A comprises first support block 941A and a first EBC 945A with an integrated lens 954A. The first fiber 946A may be fused to the first EBC 945A and/or the first support block 941A. In an embodiment, the first FAU 940A is optically coupled to a second FAU 940B. The second FAU 940B may comprise a second EBC 945B and a second support block 941B. A second fiber 946B may be fused to the second EBC 945B and/or the second support block 941B.

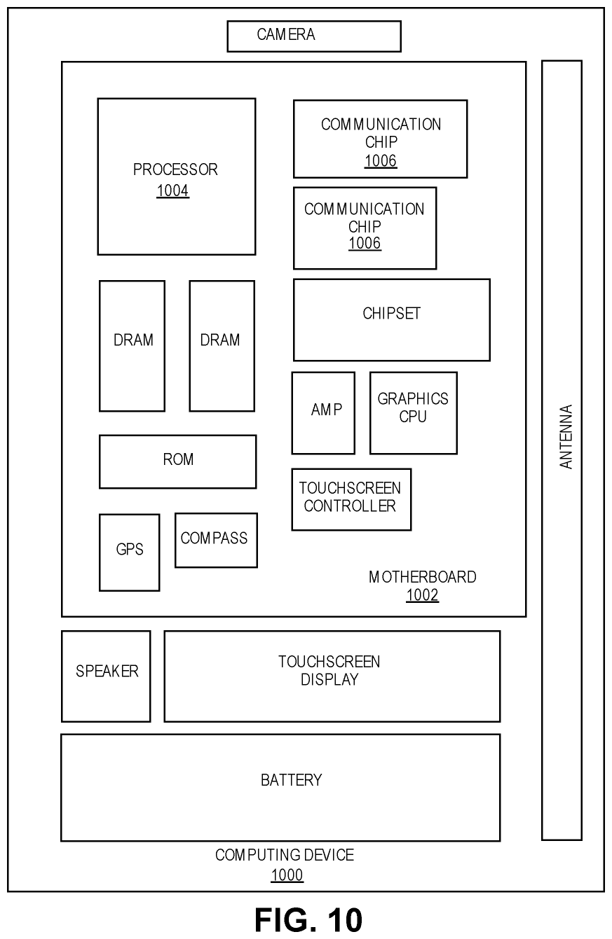

FIG. 10 illustrates a computing device 1000 in accordance with one implementation of the disclosure. The computing device 1000 houses a board 1002. The board 1002 may include a number of components, including but not limited to a processor 1004 and at least one communication chip 1006. The processor 1004 is physically and electrically coupled to the board 1002. In some implementations the at least one communication chip 1006 is also physically and electrically coupled to the board 1002. In further implementations, the communication chip 1006 is part of the processor 1004.

These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 1006 enables wireless communications for the transfer of data to and from the computing device 1000. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1006 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 1000 may include a plurality of communication chips 1006. For instance, a first communication chip 1006 may be dedicated to shorter range wireless communications such as Wi-Fi and Bluetooth and a second communication chip 1006 may be dedicated to longer range wireless communications such as GPS, EDGE, GPRS, CDMA, WiMAX, LTE, Ev-DO, and others.

The processor 1004 of the computing device 1000 includes an integrated circuit die packaged within the processor 1004. In some implementations of the disclosure, the integrated circuit die of the processor may be part of an optical package that includes an FAU with an EBC that comprise a fiber that is fused to one or more of a lens, a support block, or a lid, in accordance with embodiments described herein. The term “processor” may refer to any device or portion of a device that processes electronic data from registers and/or memory to transform that electronic data into other electronic data that may be stored in registers and/or memory.

The communication chip 1006 also includes an integrated circuit die packaged within the communication chip 1006. In accordance with another implementation of the disclosure, the integrated circuit die of the communication chip may be part of an optical package that includes an FAU with an EBC that comprise a fiber that is fused to one or more of a lens, a support block, or a lid, in accordance with embodiments described herein.

In an embodiment, the computing device 1000 may be part of any apparatus. For example, the computing device may be part of a personal computer, a server, a mobile device, a tablet, an automobile, or the like. That is, the computing device 1000 is not limited to being used for any particular type of system, and the computing device 1000 may be included in any apparatus that may benefit from computing functionality.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

These modifications may be made to the disclosure in light of the above detailed description. The terms used in the following claims should not be construed to limit the disclosure to the specific implementations disclosed in the specification and the claims. Rather, the scope of the disclosure is to be determined entirely by the following claims, which are to be construed in accordance with established doctrines of claim interpretation.

Example 1: an apparatus, comprising: a substrate with a first surface and a second surface opposite from the first surface, wherein the substrate comprises a first glass material; a lens on the second surface of the substrate, wherein the lens comprises a second glass material; and a fiber contacting the first surface of the substrate, wherein the fiber comprises a third glass material, and wherein the fiber is fused to the first surface of the substrate.

Example 2: the apparatus of Example 1, wherein the lens and the substrate are a monolithic structure.

Example 3: the apparatus of Example 1 or Example 2, wherein the lens is a beam expander lens.

Example 4: the apparatus of Examples 1-3, wherein an interface between the fiber and the substrate is seamless.

Example 5: the apparatus of Examples 1-4, wherein a composition of the first glass material and the third glass material are the same.

Example 6: the apparatus of Examples 1-5, wherein the fiber is supported by a groove in a second substrate that is adjacent to the substrate, wherein the second substrate comprises a fourth glass material, and wherein the fiber is fused to the second substrate.

Example 7: the apparatus of Example 6, wherein the fiber is fused to the second substrate along substantially an entire length of the groove.

Example 8: the apparatus of Example 6, wherein the fiber is fused to the second substrate at a plurality of discrete locations.

Example 9: the apparatus of Example 1, further comprising: a plurality of fibers, wherein individual ones of the plurality of fibers are fused to the first surface of the substrate; and a plurality of lenses, wherein individual ones of the plurality of lenses are optically coupled to a different one of the plurality of fibers.

Example 10: the apparatus of Example 9, wherein the plurality of fibers comprises 24 or more fibers.

Example 11: an apparatus, comprising: a substrate with a first surface and a second surface; a hole through the substrate from the first surface to the second surface; a fiber in the hole; a lens covering an opening of the hole on the second surface, wherein the fiber and the lens comprise a monolithic glass structure.

Example 12: the apparatus of Example 11, wherein the lens has a first diameter and the fiber has a second diameter, and wherein the first diameter is greater than the second diameter.

Example 13: the apparatus of Example 11 or Example 12, wherein an optical signal traveling through the fiber undergoes substantially no reflection at an interface between the fiber and the lens.

Example 14: the apparatus of Examples 11-13, wherein the lens is a beam expanding lens.

Example 15: the apparatus of Examples 11-14, wherein the substrate comprises glass.

Example 16: the apparatus of Examples 11-14, wherein the lens contacts the second surface of the substrate, and wherein an interface between the second surface of the substrate and the lens is seamless.

Example 17: an apparatus comprising: a first substrate, wherein the first substrate comprises a first glass material; a groove into a first surface of the first substrate; a fiber set into the groove, wherein the fiber comprises a second glass material, and wherein the fiber is fused to the first substrate; a second substrate, wherein the second substrate comprises a third glass material, and wherein the fiber and the second substrate have a seamless interface; and a lens on a second surface of the second substrate, wherein the lens comprises a fourth glass material.

Example 18: the apparatus of Example 17, wherein the lens is laser welded to an end of the fiber.

Example 19: the apparatus of Example 17 or Example 18, wherein the lens is a beam expander lens.

Example 20: the apparatus of Examples 17-19, wherein an optical signal propagated through the fiber passes into the lens with substantially no reflection.

What is claimed is:

1. An apparatus, comprising:
a substrate with a first surface and a second surface opposite from the first surface, wherein the substrate comprises a first glass material;
a lens on the second surface of the substrate, wherein the lens comprises a second glass material; and
a fiber contacting the first surface of the substrate, wherein the fiber comprises a third glass material, and wherein the fiber is fused to the first surface of the substrate.

2. The apparatus of claim 1, wherein the lens and the substrate are a monolithic structure.

3. The apparatus of claim 1, wherein the lens is a beam expander lens.

4. The apparatus of claim 1, wherein an interface between the fiber and the substrate is seamless.

5. The apparatus of claim 1, wherein a composition of the first glass material and the third glass material are the same.

6. The apparatus of claim 1, wherein the fiber is supported by a groove in a second substrate that is adjacent to the substrate, wherein the second substrate comprises a fourth glass material, and wherein the fiber is fused to the second substrate.

7. The apparatus of claim 6, wherein the fiber is fused to the second substrate along substantially an entire length of the groove.

8. The apparatus of claim 6, wherein the fiber is fused to the second substrate at a plurality of discrete locations.

9. The apparatus of claim 1, further comprising:
a plurality of fibers, wherein individual ones of the plurality of fibers are fused to the first surface of the substrate; and
a plurality of lenses, wherein individual ones of the plurality of lenses are optically coupled to a different one of the plurality of fibers.

10. The apparatus of claim 9, wherein the plurality of fibers comprises 24 or more fibers.

11. An apparatus, comprising:
a substrate with a first surface and a second surface;
a hole through the substrate from the first surface to the second surface;
a fiber in the hole; and
a lens covering an opening of the hole on the second surface, wherein the fiber and the lens comprise a monolithic glass structure.

12. The apparatus of claim 11, wherein the lens has a first diameter and the fiber has a second diameter, and wherein the first diameter is greater than the second diameter.

13. The apparatus of claim 11, wherein an optical signal traveling through the fiber undergoes substantially no reflection at an interface between the fiber and the lens.

14. The apparatus of claim 11, wherein the lens is a beam expanding lens.

15. The apparatus of claim 11, wherein the substrate comprises glass.

16. The apparatus of claim 11, wherein the lens contacts the second surface of the substrate, and wherein an interface between the second surface of the substrate and the lens is seamless.

17. An apparatus comprising:
a first substrate, wherein the first substrate comprises a first glass material;
a groove into a first surface of the first substrate;
a fiber set into the groove, wherein the fiber comprises a second glass material, and wherein the fiber is fused to the first substrate;
a second substrate, wherein the second substrate comprises a third glass material, and wherein the fiber and the second substrate have a seamless interface; and
a lens on a second surface of the second substrate, wherein the lens comprises a fourth glass material.

18. The apparatus of claim 17, wherein the lens is laser welded to an end of the fiber.

19. The apparatus of claim 17, wherein the lens is a beam expander lens.

20. The apparatus of claim 17, wherein an optical signal propagated through the fiber passes into the lens with substantially no reflection.
